(19) United States
(12) Patent Application Publication
(10) Pub. No.: US 2019/0097785 A1
(43) Pub. Date: Mar. 28, 2019

(54) Apparatus for Clock-Frequency Variation in Electronic Circuitry and Associated Methods

(71) Applicant: Silicon Laboratories Inc., Austin, TX (US)

(72) Inventor: Javier Elenes, Austin, TX (US)

(21) Appl. No.: 15/717,932

(22) Filed: Sep. 27, 2017

(51) Int. Cl. H04L 9/00; G06F 7/58; H04L 9/32; G06F 1/04

(52) U.S. Cl. CPC H04L 9/002; G06F 1/04; H04L 9/3226; G06F 7/58

(57) ABSTRACT

A method of providing access to a resource in an integrated circuit (IC) includes determining whether an attempt is made to access the resource. The method also includes obtaining a random number, and setting a frequency of a clock signal to a new value based on a value of the random number. The method further includes authenticating cryptographically a command for accessing the resource using the new value of the frequency of the clock signal.

### CROSS-REFERENCE TO RELATED APPLICATIONS

This application is related to U.S. patent application Ser. No. ______, titled “Apparatus for Protection of Electronic Circuitry and Associated Methods,” attorney docket number SILA395.

### TECHNICAL FIELD

The disclosure relates generally to security and protection of electronic circuitry and, more particularly, to apparatus for securing or protecting electronic circuitry against attacks, and associated methods.

### BACKGROUND

With advances in technology, an increasing number of circuit elements have been integrated into devices, such as integrated circuits (ICs). Furthermore, a growing number of devices, such as ICs, or subsystems, have been integrated into products. With developments such as the Internet of Things (IoT), this trend is expected to continue.

With the increasing complexity of electronic devices, such as ICs, attention has also turned to securing such devices. The growing number of circuit elements, devices, subsystems, etc., has also resulted in a corresponding increase in the number of attack vectors that may be used to compromise the security of such devices

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to an exemplary embodiment, a method of providing access to a resource in an IC includes determining whether an attempt is made to access the resource. The method also includes obtaining a random number, and setting a frequency of a clock signal to a new value based on a value of the random number. The method further includes authenticating cryptographically a command for accessing the resource using the new value of the frequency of the clock signal.

According to another exemplary embodiment, a method of providing access to a resource in an IC includes determining whether an attempt is made to access the resource. The method further includes authenticating cryptographically a command for accessing the resource by repeating at least once: (a) obtaining first and second random numbers; (b) setting a duration of a wait period based on a value of the first random number; and (c) setting a frequency of a clock signal to a new value based on a value of the second random number for the duration of the wait period.

According to another exemplary embodiment, an IC includes a clock generator circuit to provide a countermeasure against an attempt to access a resource in the IC. The clock generator circuit provides at least one clock signal having a frequency derived from a first random number. The at least one clock signal is used to authenticate a command used to attempt to access the resource in the IC.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 shows a conventional technique for attacking an electronic device.

FIG. 2 shows another conventional technique for attacking an electronic device

FIG. 3 shows a flow diagram for a process of authenticating access to a resource in an electronic device according to an exemplary embodiment.

FIG. 4 shows a clock generator circuit according to an exemplary embodiment.

FIG. 5 shows a flow diagram for a process of authenticating access to a resource in an electronic device according to an exemplary embodiment.

FIG. 6 shows a circuit arrangement for authenticating access to a resource in an IC according to an exemplary embodiment.

FIG. 7 shows a flow diagram for a process of authenticating access to a resource in an electronic device according to an exemplary embodiment.

FIG. 8 shows a circuit arrangement for authenticating access to a resource in an IC according to an exemplary embodiment.

FIG. 9 shows a block diagram of an IC according to an exemplary embodiment.

FIG. 10 shows a block diagram of a system for information processing according to an exemplary embodiment.

### DETAILED DESCRIPTION

The disclosed concepts relate generally to security and protection of electronic circuitry or devices, such as ICs (generally electronic circuitry). More specifically, the disclosed concepts provide apparatus and methods for securing or protecting electronic circuitry against attacks. In various embodiments, the protection takes the form of countermeasures against attacks, and may be applied to various resources or tokens associated with or included in the electronic circuitry.

As described below, apparatus and associated methods according to various embodiments provide countermeasures to attacks (e.g., hostile attempts to access resources or tokens) against electronic circuitry. The countermeasures provide a mechanism for thwarting attacks against resources or tokens in the electronic circuitry.

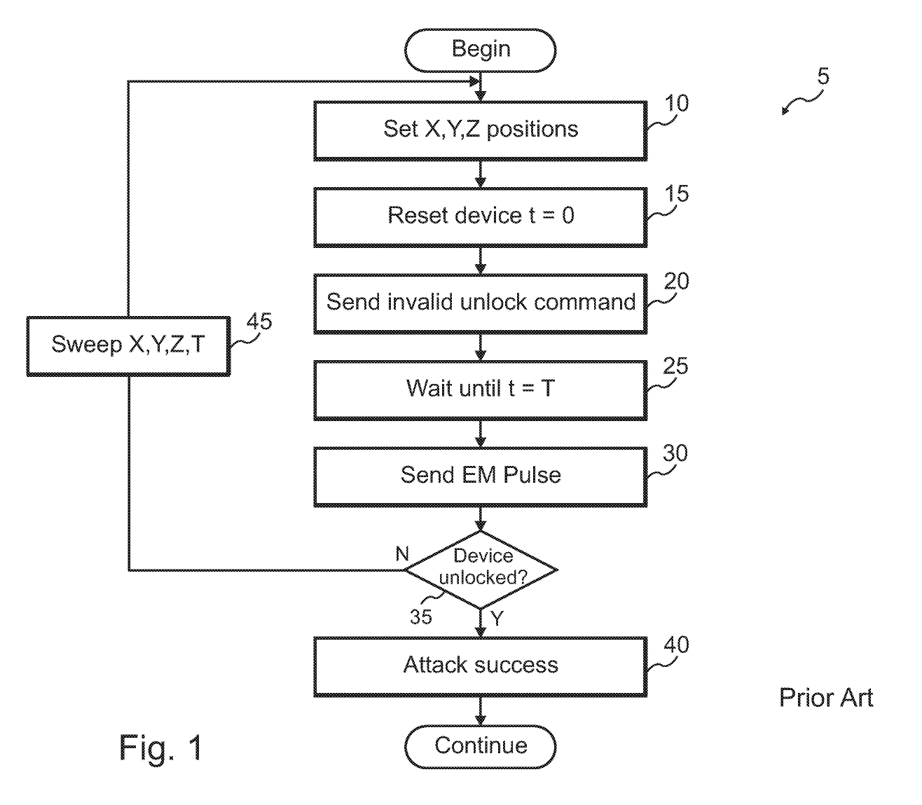

FIG. 1 shows a flow diagram 5 for a conventional process for attacking an electronic device. The purpose of the attack is to access certain features or circuitry of the IC. The process involves the application of an electromagnetic (EM) pulse to attack the electronic device, such as an IC. In the process shown, the EM pulse is used to unlock the IC and, thus, gain access to it.

At 10, x, y, and z positions or coordinates are set for the apparatus that applies the EM pulse with respect to the IC. The x, y, and z coordinates pertain to the positioning of the EM pulse apparatus relative to the IC to be subjected to the EM pulse. At 15, the IC is reset, e.g., by applying an appropriate voltage or signal to a reset pin of the IC. The device reset occurs at an initial time, i.e., time t=0.

In response to the reset signal or voltage the IC is reset, and is therefore in a generally known configuration. At 20, an invalid unlock command is sent to the IC. At 25, a wait period is exercised. In this particular case, the process waits until a period T has passed. In other words, the process waits until t=T. The parameter T denotes a wait period, the value of which depends on various factors, such as the characteristics of the apparatus that applies the EM pulse, the attributes of the EM pulse (e.g., how rapidly it affects the electronic device), the characteristics of the IC, etc.

At 30, the EM pulse is sent or applied to the IC. As persons of ordinary skill in the art know, a variety of apparatus and techniques may be used to apply the EM pulse to the IC. For example, a probe may apply a high voltage or electromagnetic field to the packaging of the IC. The application of the EM pulse is meant to unlock the IC, for example, by bypassing its security features. As persons of ordinary skill in the art understand, however, other techniques for injecting faults exist, and may be applied, as desired. Examples include shining a laser on a specific part of the circuit, or applying a voltage pulse directly into the IC die with a tungsten probe. These methods entail de-capsulating the device to gain physical access to the die.

At 35 a check is made whether the IC is unlocked as a result of the application of the EM pulse. The check may be made, for example, by determining whether some circuitry in the IC may be accessed. If so, at 40 the attack is deemed successful. The attacker may subsequently use the various features or circuitry in the IC for general or specific purposes. If not, at 45 the x, y, and z coordinates and the time period T are swept. More specifically, new or updated values for x, y, and z coordinates and the time period T are selected in preparation for another attack on the IC. The new or updated values are selected using a variety of techniques, as persons of ordinary skill in the art understand.

Control is subsequently returned to 10. The new or updated x, y, and z coordinates and the time period T are set. Thereafter another attack is performed, as described above.

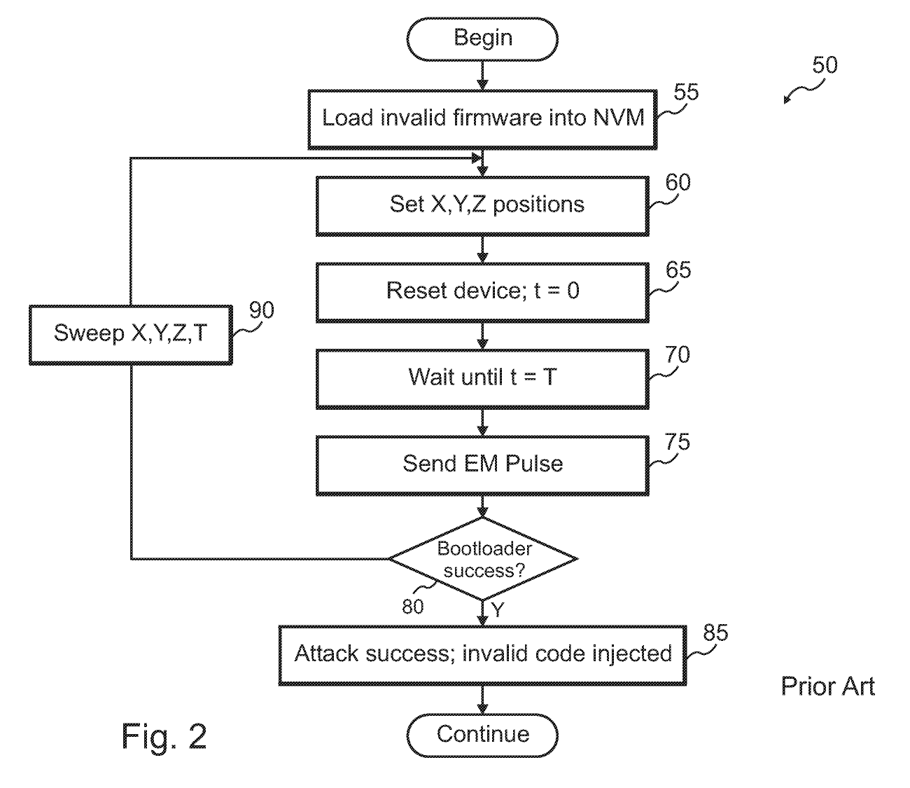

FIG. 2 shows another flow diagram 50 for a conventional process for attacking an electronic device. In this case, attempt(s) are made to unlock an IC in order to load invalid (or malicious) firmware into it.

Similar to the process described in connection with FIG. 1, the process shown in FIG. 2 involves the application of an EM pulse to attack the electronic device, such as an IC. In the process shown, the EM pulse is used to unlock the IC in order to update its firmware. As noted above, however, techniques other than applying EM pulses may be used to attack the IC or inject fault.

At 55, the invalid firmware is loaded into the non-volatile memory (NVM) of the IC. The NVM holds firmware that is typically used to boot or start the IC, such as a microcontroller unit (MCU). At 60, x, y, and z positions or coordinates are set for the apparatus that applies the EM pulse with respect to the IC. The x, y, and z coordinates pertain to the positioning of the EM pulse apparatus relative to the IC to be subjected to the EM pulse. At 65, the IC is reset, e.g., by applying an appropriate voltage or signal to a reset pin of the IC. The device reset occurs at an initial time, i.e., time t=0. In response to the reset signal or voltage the IC is reset, and is therefore in a generally known configuration.

At 70, a wait period is exercised. In this particular case, the process waits until a period T has passed. In other words, the process waits until t=T. The parameter T denotes a wait period, the value of which depends on various factors, such as the characteristics of the apparatus that applies the EM pulse, the attributes of the EM pulse (e.g., how rapidly it affects the electronic device), the characteristics of the IC, etc.

At 75, the EM pulse is sent or applied to the IC. As persons of ordinary skill in the art know, a variety of apparatus and techniques may be used to apply the EM pulse to the IC. For example, a probe may apply a high voltage or electromagnetic field to the packaging of the IC. The application of the EM pulse is meant to unlock the IC, for example, by bypassing its security features.

At 80 a check is made whether, as a result of the application of the EM pulse, the IC bootloader succeeds with the invalid firmware loaded. If so, at 85 the attack is deemed successful, as invalid code is injected into the IC. The attacker may subsequently use the various features or circuitry in the IC for general or specific purposes. If not, at 90 the x, y, and z coordinates and the time period T are swept. More specifically, new or updated values for x, y, and z coordinates and the time period T are selected in preparation for another attack on the IC. The new or updated values are selected using a variety of techniques, as persons of ordinary skill in the art understand.

Control is subsequently returned to 55. The new or updated x, y, and z coordinates and the time period T are set. Thereafter another attack is performed, as described above.

One aspect of the disclosure relates to defending or protecting against an attack by authenticating commands as part of the attack. The commands may generally seek to access, use, program, or otherwise manipulate one or more resources in an electronic device, such as an IC. Without limitation, the resource may be a circuit, a token, an interface, a block, hardware, firmware, software, or other resource in an electronic device, such as IC, as persons of ordinary skill in the art will understand.

In cases where the resource is an interface, the interface may constitute a variety of devices, circuits, or blocks, as persons of ordinary skill in the art will understand. Without limitation, the interface may constitute a debug interface. Examples of debug interfaces include serial interfaces, Joint Test Action Group (JTAG) interfaces, parallel interfaces, interfaces to access memory or other resource in an IC, etc.

In the case of a debug interface, the interface is typically open during development, production, and test of the IC, such as an MCU. Access to the debug interface typically grants full access to the various resources of the IC, and full control of it.

As such, access to the debug interface may provide access to other secret or valuable information. Examples include secret keys or tokens, data, and the like. Examples of secret keys or tokens include private keys (e.g., as used in a public-private key infrastructure or setup), passwords, passphrases, secret words or phrases, hashes of passwords, encryption keys (e.g., Advanced Encryption Standard (AES) keys), cipher keys, and the like, as persons of ordinary skill in the art will understand.

Because of the sensitive information that may be accessed via the debug interface, the debug interface is typically locked down before the IC is shipped for general or field use. Access to the debug interface may be desired later, for example, to determine faults or defects in the IC, such as might develop during field use.

To regain access to the IC, typically cryptographic authentication (for example, using one of the techniques described above) is used. A number of attacks, such as those described above, may be used by an attacker to bypass or circumvent the authentication in order to gain access to the resources, such as cryptographic resources. Exemplary embodiments provide protection or countermeasures against such attacks.

More specifically, typical electronic devices, such as ICs, operate on a fixed clock frequency. As such, the timing of various operations performed by the digital logic in the device is deterministic and repeatable. This characteristic can be methodically exploited by an attacker in order to compromise the security of the device (for example, by unlocking debug access gaining full control of the device), as described above. The attacker does not need to know anything about the timing or nature of internal operations being executed by the device. By merely communicating with the device using legitimate application programming interfaces (APIs) an attack may be launched.

Apparatus and processes according to various embodiments provide a countermeasure to such attacks by removing the predictability that attacks exploit. To do so, the frequency of one or more clock signals used by the device are changed. The change in the frequency of clock signal(s) results in non-deterministic (or less deterministic) operations.

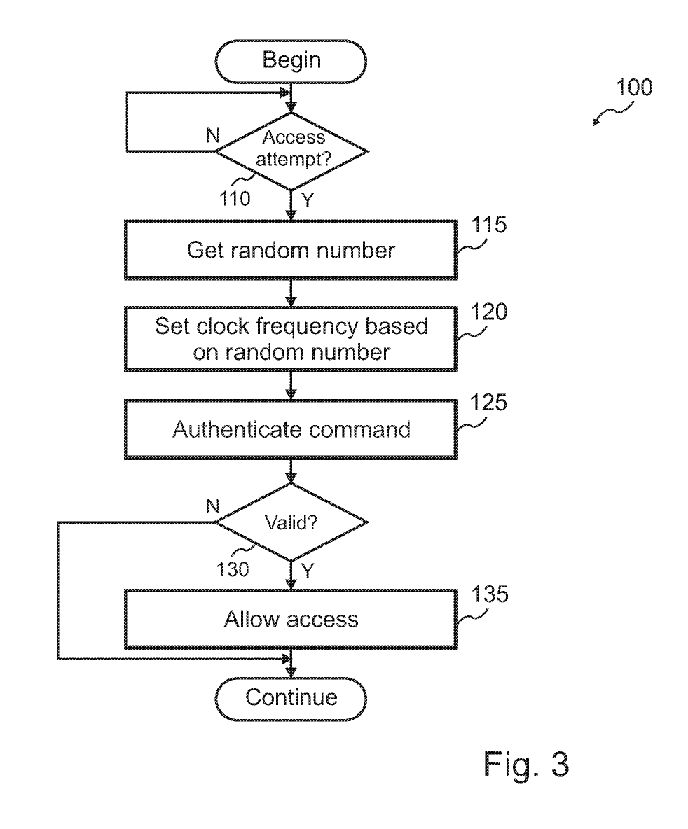

FIG. 3 shows a flow diagram 100 for a process of authenticating access to a resource in an electronic device according to an exemplary embodiment. At 110 a check is made for an attempt to access the resource in the IC, such as the resources mentioned above. Attempting access to the resource may entail using an authentication token, such as certificate, secret key, etc., as persons of ordinary skill in the art will understand. If no attempt is made for access, control returns to 110. Otherwise, if an access attempt is made or detected, control is passed to 115.

At 115, a random number, x (or more than one random number, as described below) is generated or obtained (e.g., from a source within the apparatus). Categories of random numbers that may be generated or obtained include: non-secure pseudorandom, cryptographically secure pseudorandom, chaotic true random, and quantum true random, as persons of ordinary skill in the art understand. Furthermore, random number generators may be based on cryptographic primitives (e.g., ANSI X9.62-2005 Annex D, NIST SP 800-90A rev. 1, and ANSI X9.31 Appendix A.2.4); number theoretic designs (e.g., Blum-Micali and Blum-Blum-Shub); and special-purpose designs (e.g., Fortuna, HC-256, Random123 suite, Yarrow, eSTREAM portfolio, ISAAC, and ChaCha20), as persons of ordinary skill in the art understand.

In exemplary embodiments, one or more random number generators based on one or more (or other) techniques may be used. Furthermore, in exemplary embodiments, designs based on one or more of hardware, firmware, and software may be used.

As described below in detail, the random number x is used to set one or more clock frequencies used in the electronic device. By setting (or varying or changing or modifying or configuring or programming) the frequency of one or more clock signals used in the electronic apparatus, countermeasures may be provided against attacks. The setting or varying of one or more clock signals varies the timing at which the protected operations/methods (such as the processes shown) occur.

At 120, the clock frequency is set based on the random number, x. In exemplary embodiments, a variety of techniques may be used, and are contemplated, for setting the clock frequency. Several examples are described below.

Generally, a function (or procedure or mathematical relation or equation) may be used to set the clock frequency based on several constants or variables. The random number is mapped into a range of clock frequencies that are used by the device.

In some embodiments, a “set-and-forget” technique is used for setting the clock frequency. In other words, the frequency of the clock signal is set and used during authentication (described below). More specifically, assuming a random number x, the new clock frequency ƒ_{new} is derived as ƒ_{new}=min{max[ƒ(x), ƒₘᵢₙ], ƒₘₐₓ}, where ƒ(x) represents a function that maps random number x to a clock frequency, and min, max, ƒₘᵢₙ, and ƒₘₐₓ represent the minimum function (returns the minimum of its arguments), the maximum function (returns the maximum of its arguments), the minimum of the valid range of clock frequency that may be used, and the maximum of the valid range of clock frequency that may be used, respectively.

Generally, function ƒ( ) may constitute any desired function. Examples include linear functions, exponential functions, arithmetic series functions, and geometric series functions. Other types of functions may be used, as persons of ordinary skill in the art will understand, and as desired.

The minimum of the valid range of clock frequency that may be used, and the maximum of the valid range of clock frequency that may be used are generally based on the characteristics of the electronic device. For example, the specifications of an electronic device such as IC may include the minimum and maximum clock frequencies with which the device operates or is desired to operate.

In some embodiments, the clock frequency is set or changed more than once during an operation such as an authentication operation. In this scenario, assuming a random number x, the new clock frequency ƒ_{new} is derived as ƒ_{new}=min{max[ƒ(x), ƒₘᵢₙ], ƒₘₐₓ}, and is applied, i.e., the clock frequency is set. A wait period of several clock cycles, e.g., N cycles, where N denotes a positive integer, is inserted. During the wait period, the clock frequency is ƒ_{new}. At the conclusion of the wait period, another random number is obtained, and the process repeats by obtaining a new clock frequency ƒ_{new}, and so on. Note that the number of clock cycles during the wait period, i.e., N, may also be changed between the iterations of this process (i.e., between the setting of clock signal frequency to one value and setting the clock signal frequency to another value in a subsequent iteration).

In some embodiments, more than one random number may be used. For example, random numbers x and y may be used. In this scenario, random numbers x and y are used to set the new clock signal frequency and the number of clock cycles in the wait period. More specifically, random numbers x and y are obtained. The new clock frequency ƒ_{new} is derived as ƒ_{new}=min{max[ƒ(x), ƒₘᵢₙ], ƒₘₐₓ}. The number of wait cycles, i.e., N, is variable in this scenario, and is obtained from N=ƒ{max[ƒ(y), Nₘᵢₙ], Nₘₐₓ}, where Nₘᵢₙ and Nₘₐₓ represent, respectively, the minimum and maximum values of N (e.g., specified by the designer or user of the electronic device).

As noted, during the wait period, the clock frequency is ƒ_{new}. At the conclusion of the wait period, another random number x and another random number y are obtained, and the process repeats by obtaining a new clock frequency ƒ_{new}, and new number of clock cycles in the wait period (N), and so on.

At 125 the command used to attempt access is authenticated. The authentication may be made using a variety of techniques, such as the techniques described above (decryption, cryptography, etc.). At 130 a check is made whether the command was successfully authenticated and, thus, is a valid command for gaining access to the resource. If not, access to the resource is not granted. If valid, however, at 135, access to the resource is allowed.

Although the description above discusses setting a clock frequency, similar techniques may be used to set more than one clock frequency. For example, if the electronic apparatus uses more than one clock signal, the frequencies of the clock signals may be set using the random number. In some embodiments, the frequencies of the clock signals are set using the same function (or procedure), such as the functions described above, is used to set all of the clock frequencies.

In some embodiments, the frequencies of the various clock signals are set using different functions. In some embodiments, the frequencies of some of the clock signals are set using one function, while the frequencies of some of the other clock signals are set using a different function.

Furthermore, in some embodiments, more than one random number may be used to set clock signal frequencies. For example, in some embodiments, the frequencies of the various clock signals are set using different random numbers and/or functions. In some embodiments, the frequencies of some of the clock signals are set using one random number and/or function, while the frequencies of some of the other clock signals are set using a different random number and/or function. Thus, a variety of combinations of random numbers and functions may be used to set cock signal frequencies.

The above schemes for setting clock signal frequencies are provided as examples, and not as limitations. Generally, a variety of other configurations for setting the frequencies of clock signals are possible and contemplated, as persons of ordinary skill in the art will understand.

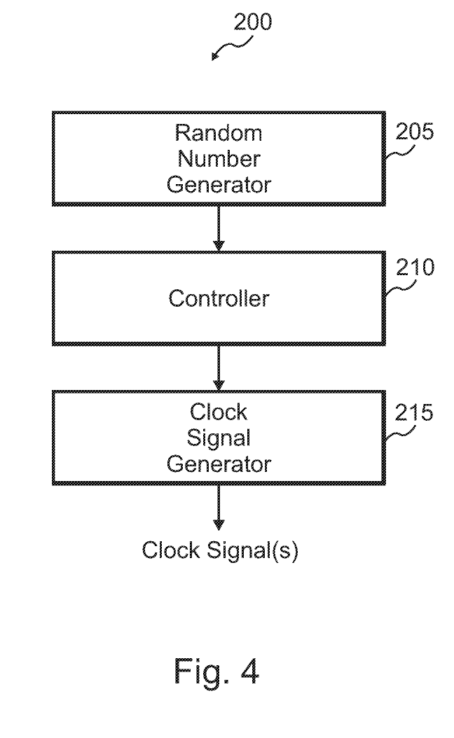

FIG. 4 shows a clock generator circuit 200 according to an exemplary embodiment. Clock generator circuit 200 includes random number generator 205. Random number generator 205 generates one or more random numbers, as described above.

Clock generator circuit 200 also includes controller 210. Controller 210 uses the random number(s) provided by random number generator 205, and calculates the new clock signal frequency (and in some embodiments) the number of clock cycles in the wait period, N, as described above).

Clock generator circuit 200 further includes clock signal generator 215. Clock signal generator 215 is used to generate a clock signal having a desired frequency. More specifically, when controller 210 calculates the new clock signal frequency, it sets the clock frequency to the calculated value by issuing command and/or control signals to clock signal generator 215. In response, clock signal generator 215 generates a clock signal (or more than one clock signal, as described above), having the desired new clock signal frequency.

Clock signal generator may include a variety of circuitry to generate one or more clock signals. For example, in some embodiments, a voltage-controlled oscillator (VCO) may be used. In such a scenario, controller 210 provides a signal, such as a control voltage, that causes the VCO to generate clock signal(s) (or signal(s) from which clock signal(s) may be derived), as persons of ordinary skill in the art will understand. In embodiments where a wait period is used, a counter may be employed to count the number of clock cycles, N. The counter may be included in controller 210, as desired.

Once the frequency of the clock signal(s) is set, the clock signal(s) is used for authentication purposes, as described above. The authentication may be performed using a variety of circuitry, as persons of ordinary skill in the art will understand. Without limitation, authentication may be performed in some embodiments by using special-purpose or custom circuitry. As an alternative, in some embodiments, authentication may be performed using a processor or general computing or information processing circuitry (which may be present in the electronic device).

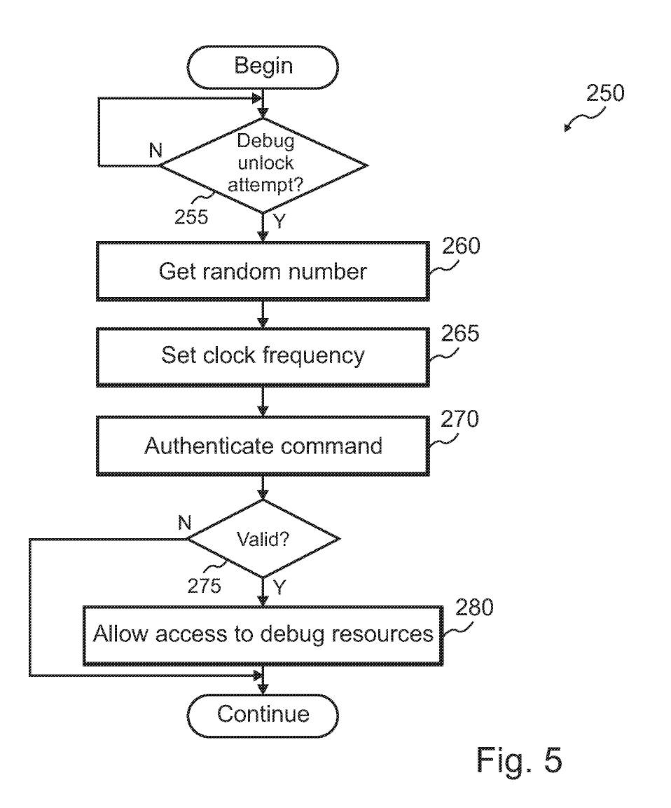

FIG. 5 shows a flow diagram 250 for a process of authenticating access to a resource in an electronic device according to an exemplary embodiment. In the embodiment shown, the resource constitutes a debug interface or resource.

At 255 a check is made for an attempt to access the debug interface. Attempting access to the debug interface may entail using an authentication token, such as certificate, secret key, etc., as persons of ordinary skill in the art will understand. If no attempt is made for access, control returns to 255. Otherwise, if an access attempt is made or detected, control is passed to 260.

At 260, a random number (or more than one random number, as described above) is generated or obtained, for example, using the techniques described above. At 265, a clock frequency is derived from the random number, and the clock frequency is set to the derived value, for example, using the techniques described above.

At 270 the command used to attempt access to the debug interface is authenticated. The authentication may be made using a variety of techniques, such as the techniques described above (decryption, cryptography, etc.). At 275 a check is made whether the command was successfully authenticated and, thus, is a valid command for gaining access to the debug interface. If not, access to the resource is not granted. If valid, however, at 280, access to the debug interface is allowed.

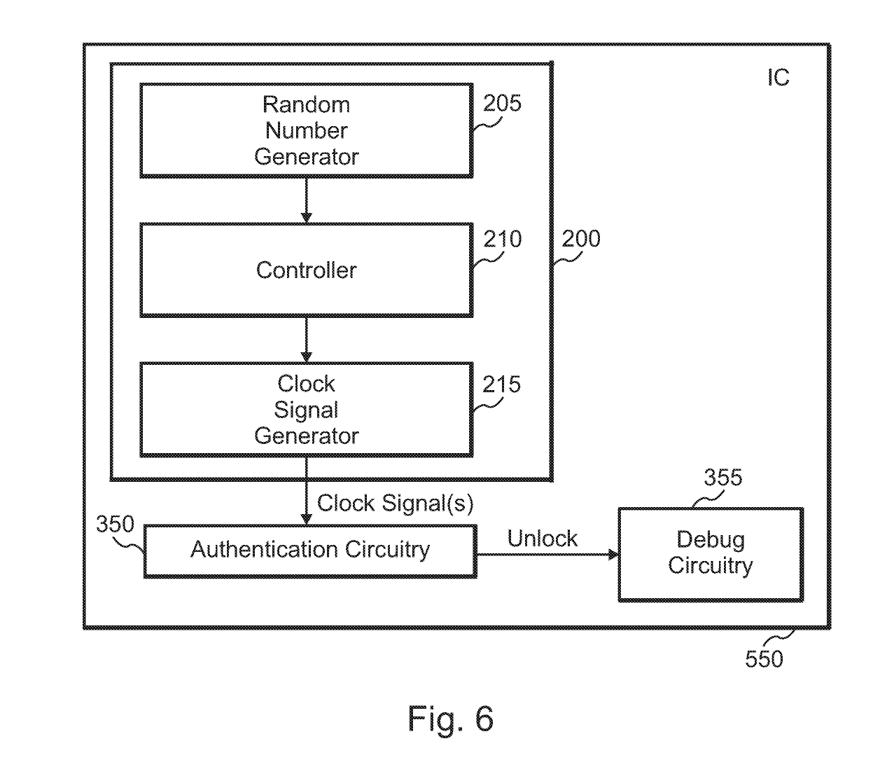

FIG. 6 shows a circuit arrangement for authenticating access to a resource in an IC 550 according to an exemplary embodiment. In the example shown, the resource constitutes debug circuitry (or interface) 355 of IC 550. As persons of ordinary skill in the art will understand, however, the circuitry shown may be used to authenticate access to other resources, for example, as shown in FIG. 3, by making appropriate modifications.

Referring again to FIG. 6, IC 550 includes clock generator circuit 200 which, as described above, includes random number generator 205, controller 210, and clock signal generator 215. Clock generator circuit 200 provides one or more clock signals to authentication circuitry 350. Authentication circuitry 350 authenticates one or more commands used to attempt access to debug circuitry 355. Authentication circuitry 350 may be implemented in a variety of ways, as described above.

When authentication by authentication circuitry 350 succeeds, an unlock signal is provided to debug circuitry 355. In response to the unlock signal, debug circuitry 355 allows access to its resources.

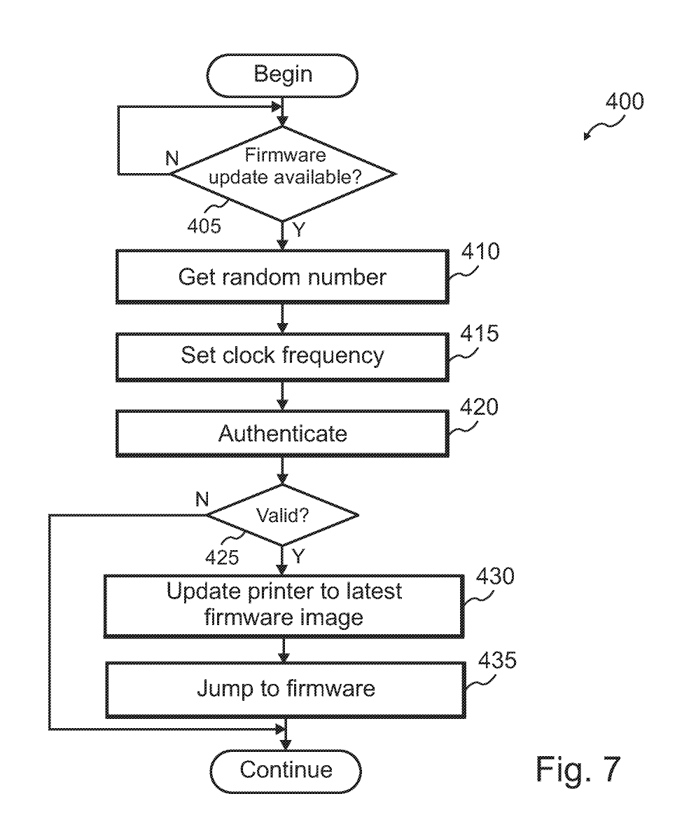

FIG. 7 shows a flow diagram 400 for a process of authenticating access to a resource in an electronic device according to an exemplary embodiment. More specifically, the resource in this embodiment is the firmware used in an IC. Access to the firmware typically is used to update the firmware.

At 405 a check is made whether a firmware update is available, which may result, for instance, from an attempt to access the firmware in order to update it. Attempting to update the firmware may entail using an authentication token, such as certificate, secret key, etc., as persons of ordinary skill in the art will understand. If no firmware update is available, control returns to 405. Otherwise, control is passed to 410.

At 410, a random number (or more than one random number, as described above) is generated or obtained, for example, using the techniques described above. At 415, a clock frequency is derived from the random number, and the clock frequency is set to the derived value, for example, using the techniques described above.

At 420 the command used for updating the firmware is authenticated. The authentication may be made using a variety of techniques, such as the techniques described above (decryption, cryptography, etc.). At 425 a check is made whether the command was successfully authenticated and, thus, is a valid command for updating the firmware. If not, updating the firmware is not allows. If valid, however, at 430, a pointer is updated to point to the latest (or new) firmware image. At 435, a jump is made to the new firmware.

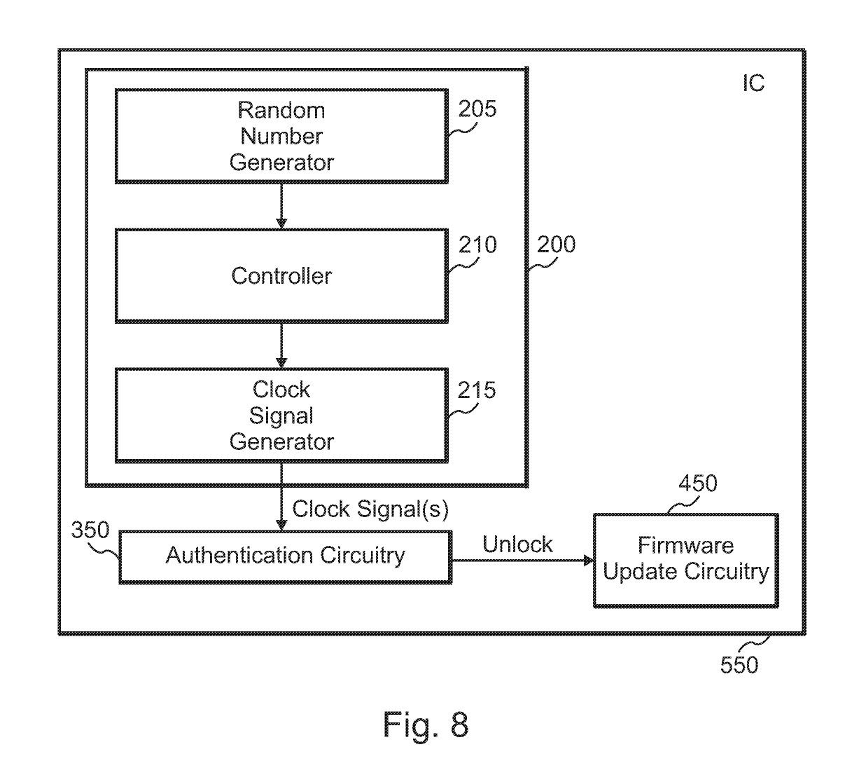

FIG. 8 shows a circuit arrangement for authenticating access to a resource in an IC 550 according to an exemplary embodiment. In the example shown, the resource constitutes circuitry related to the firmware of IC 550, specifically firmware update circuitry 450. As persons of ordinary skill in the art will understand, however, the circuitry shown may be used to authenticate access to other resources, for example, as shown in FIG. 3, by making appropriate modifications.

Referring again to FIG. 8, IC 550 includes clock generator circuit 200 which, as described above, includes random number generator 205, controller 210, and clock signal generator 215. Clock generator circuit 200 provides one or more clock signals to authentication circuitry 350. Authentication circuitry 350 authenticates one or more commands used to attempt access to debug circuitry 355. Authentication circuitry 350 may be implemented in a variety of ways, as described above.

When authentication by authentication circuitry 350 succeeds, an unlock signal is provided to firmware update circuitry 450. In response to the unlock signal, firmware update circuitry 450 allows the firmware of IC 550 to be updated. Firmware update circuitry 450 may do so by receiving a bitstream or other information that includes the new firmware, and storing the new firmware in NVM circuitry in IC 550, or use other techniques to update the firmware, as persons of ordinary skill in the art will understand.

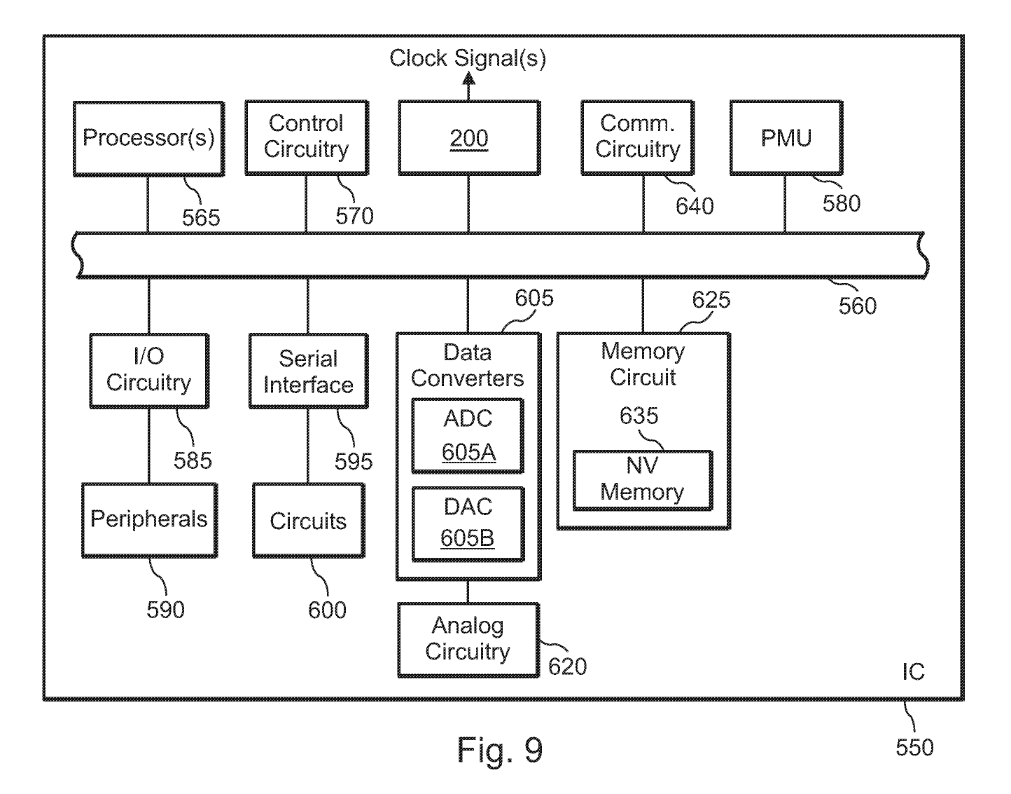

According to one aspect of the disclosure, apparatus and associated methods for protecting electronic circuitry and devices against attacks may be used with or included in a variety of circuits, blocks, subsystems, and/or systems. For example, in some embodiments, clock generator circuitry, such as clock generator circuit 200 described above and used to authenticate access to various resources or tokens, may be integrated in an IC, such as an MCU. FIG. 9 shows a circuit arrangement for such an exemplary embodiment.

The circuit arrangement includes an IC 550, which constitutes or includes an MCU. IC 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductor elements (e.g., traces, devices, etc.) for communicating information, such as data, commands, status information, and the like.

IC 550 may include link 560 coupled to one or more processors 565, clock generator circuit 200, and power management circuitry or power management unit (PMU) 580. In some embodiments, processor(s) 565 may include circuitry or blocks for providing information processing (or data processing or computing) functions, such as central-processing units (CPUs), arithmetic-logic units (ALUs), and the like. In some embodiments, in addition, or as an alternative, processor(s) 565 may include one or more DSPs. The DSPs may provide a variety of signal processing functions, such as arithmetic functions, filtering, delay blocks, and the like, as desired.

In some embodiments, processor(s) 565 may be used to provide countermeasures to attacks. For example, if processor(s) 565 includes circuitry or other resources for authenticating commands or requests, such circuitry or resources may be used for authentication purposes, as described above.

Clock generator circuit 200 generates one or more clock signals that facilitate or control the timing of operations of one or more blocks in IC 550. Clock generator circuit 200 may also control the timing of operations that use link 560, as desired. In some embodiments, clock generator circuit 200 may provide one or more clock signals via link 560 to other blocks in IC 550, as desired. As noted above, clock generator circuit 200 changes the frequency of one or more clock signals in order to provide a countermeasures against attacks on one or more resources of IC 550.

In some embodiments, PMU 580 may reduce an apparatus's (e.g., IC 550) clock speed, turn off the clock, reduce power, turn off power, disable (or power down or place in a lower power consumption or sleep or inactive or idle state), enable (or power up or place in a higher power consumption or normal or active state) or any combination of the foregoing with respect to part of a circuit or all components of a circuit, such as one or more blocks in IC 550. Further, PMU 580 may turn on a clock, increase a clock rate, turn on power, increase power, or any combination of the foregoing in response to a transition from an inactive state to an active state (including, without limitation, when processor(s) 565 make a transition from a low-power or idle or sleep state to a normal operating state).

Link 560 may couple to one or more circuits 600 through serial interface 595. Through serial interface 595, one or more circuits or blocks coupled to link 560 may communicate with circuits 600. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with one or more blocks coupled to link 560, e.g., processor(s) 365, memory circuit 625, etc.

In exemplary embodiments, peripherals 590 may include a variety of circuitry, blocks, and the like. Examples include I/O devices (keypads, keyboards, speakers, display devices, storage devices, timers, sensors, etc.). Note that in some embodiments, some peripherals 590 may be external to IC 550. Examples include keypads, speakers, and the like.

In some embodiments, with respect to some peripherals, I/O circuitry 585 may be bypassed. In such embodiments, some peripherals 590 may couple to and communicate with link 560 without using I/O circuitry 585. In some embodiments, such peripherals may be external to IC 550, as described above.

Link 560 may couple to analog circuitry 620 via data converter(s) 605. Data converter(s) 605 may include one or more ADCs 605A and/or one or more DACs 605B. ADC(s) 605A receive analog signal(s) from analog circuitry 620, and convert the analog signal(s) to a digital format, which they communicate to one or more blocks coupled to link 560. Conversely, DAC(s) 605B receive digital signal(s) from one or more blocks coupled to link 560, and convert the digital signal(s) to analog format, which they communicate to analog circuitry 620.

Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to IC 550 to form more complex systems, sub-systems, control blocks or systems, feedback systems, and information processing blocks, as desired.

Control circuitry 570 couples to link 560. Thus, control circuitry 570 may communicate with and/or control the operation of various blocks coupled to link 560 by providing control information or signals. In some embodiments, control circuitry 570 also receives status information or signals from various blocks coupled to link 560. In addition, in some embodiments, control circuitry 570 facilitates (or controls or supervises) communication or cooperation between various blocks coupled to link 560. In some embodiments, control circuitry 570 may operate in conjunction with controller 210 (see FIGS. 4, 6, and 8). In some embodiments, some or all of the circuitry in control circuitry 570 may replace some or all of the circuitry in controller 210, as desired.

In some embodiments, control circuitry 570 may initiate or respond to a reset operation or signal. The reset operation may cause a reset of one or more blocks coupled to link 560, of IC 550, etc., as person of ordinary skill in the art will understand. For example, control circuitry 570 may cause PMU 580 to reset to an initial or known state. In exemplary embodiments, control circuitry 570 may include a variety of types and blocks of circuitry. In some embodiments, control circuitry 570 may include logic circuitry, finite-state machines (FSMs), or other circuitry to perform operations such as the operations described above.

Communication circuitry 640 couples to link 560 and also to circuitry or blocks (not shown) external to IC 550. Through communication circuitry 640, various blocks coupled to link 560 (or IC 550, generally) can communicate with the external circuitry or blocks (not shown) via one or more communication protocols. Examples of communications include USB, Ethernet, and the like. In exemplary embodiments, other communication protocols may be used, depending on factors such as design or performance specifications for a given application, as person of ordinary skill in the art will understand.

As noted, memory circuit 625 couples to link 560. Consequently, memory circuit 625 may communicate with one or more blocks coupled to link 560, such as processor(s) 365, control circuitry 570, I/O circuitry 585, etc. Memory circuit 625 provides storage for various information or data in IC 550, such as operands, flags, data, instructions, and the like, as persons of ordinary skill in the art will understand. Memory circuit 625 may support various protocols, such as double data rate (DDR), DDR2, DDR3, DDR4, and the like, as desired.

In some embodiments, memory read and/or write operations by memory circuit 625 involve the use of one or more blocks in IC 550, such as processor(s) 565. A direct memory access (DMA) arrangement (not shown) allows increased performance of memory operations in some situations. More specifically, DMA (not shown) provides a mechanism for performing memory read and write operations directly between the source or destination of the data and memory circuit 625, rather than through blocks such as processor(s) 565.

Memory circuit 625 may include a variety of memory circuits or blocks. In the embodiment shown, memory circuit 625 includes non-volatile (NV) memory 635. In addition, or instead, memory circuit 625 may include volatile memory (not shown), such as random access memory (RAM). NV memory 635 may be used for storing information related to performance, control, or configuration of one or more blocks in IC 550. For example, NV memory 635 may store configuration information related to setting the frequencies of the clock signals generated by clock generator circuit 200, such as mapping random numbers to frequency values (e.g., via a lookup table), etc.

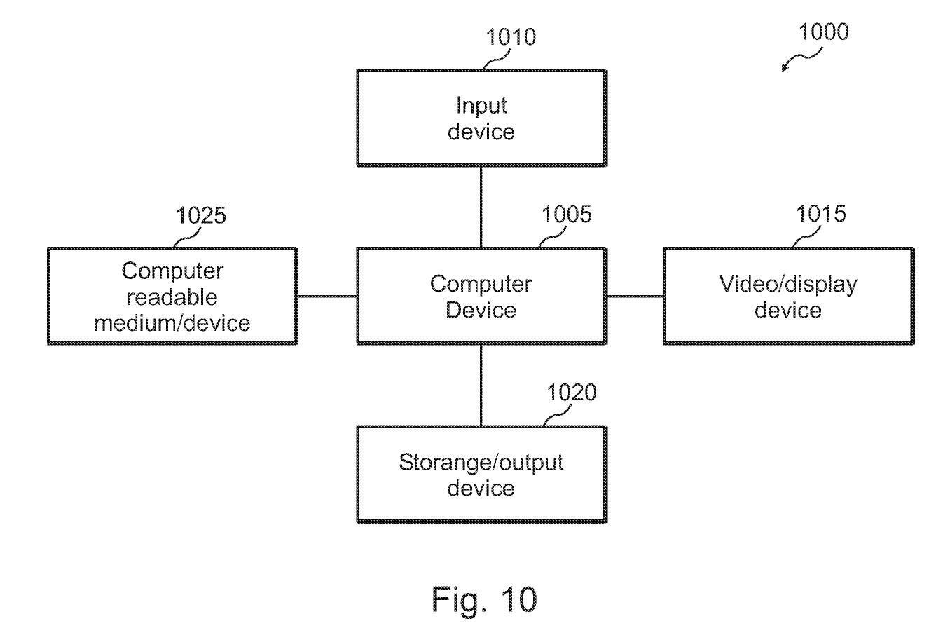

According to one aspect of the disclosure, one may perform, run, or execute the disclosed algorithms, processes, methods, or software on computer systems, devices, processors, controllers, etc. FIG. 10 shows a block diagram of an exemplary system 1000 for processing information that may be used in exemplary embodiments. For example, in some embodiments, system 1000 may be used to realize or implement one or more processes for providing countermeasures against attacks, such as the processes shown in FIG. 3, FIG. 5, and/or FIG. 7. Without limitation, system 1000 may be used in exemplary embodiments for authenticating access to resources in an electronic device, such as an IC, according to various embodiments, such as those described above.

System 1000 includes a computer device 1005, an input device 1010, a video/display device 1015, and a storage/output device 1020, although one may include more than one of each of those devices, as desired. Computer device 1005 couples to input device 1010, video/display device 1015, and storage/output device 1020. System 1000 may include more than one computer device 1005, for example, a set of associated computer devices or systems, as desired.

Typically, system 1000 operates in association with input from a user. The user input typically causes system 1000 to perform specific desired information-processing tasks, including processes for authenticating access to resources in an electronic device, such as an IC, according to various embodiments. System 1000 in part uses computer device 1005 to perform those tasks. Computer device 1005 includes information-processing circuitry, such as a central-processing unit (CPU), controller, microcontroller unit (MCU), etc., although one may use more than one such device or information-processing circuitry, as persons skilled in the art would understand.

Input device 1010 receives input from the user and makes that input available to computer device 1005 for processing. The user input may include data, instructions, or both, as desired. Input device 1010 may constitute an alphanumeric input device (e.g., a keyboard), a pointing device (e.g., a mouse, roller-ball, light pen, touch-sensitive apparatus, for example, a touch-sensitive display, or tablet), or both. The user operates the alphanumeric keyboard to provide text, such as ASCII characters, to computer device 1005. Similarly, the user operates the pointing device to provide cursor position or control information to computer device 1005.

Video/display device 1015 displays visual images to the user. Video/display device 1015 may include graphics circuitry, such as graphics processors, as desired. The visual images may include information about the operation of computer device 1005, such as graphs, pictures, images, and text. Video/display device 1015 may include a computer monitor or display, a projection device, and the like, as persons of ordinary skill in the art would understand. If system 1000 uses a touch-sensitive display, the display may also operate to provide user input to computer device 1005.

Storage/output device 1020 allows computer device 1005 to store information for additional processing or later retrieval (e.g., softcopy), to present information in various forms (e.g., hardcopy), or both. As an example, storage/output device 1020 may include a magnetic, optical, semiconductor, or magneto-optical drive capable of storing information on a desired medium and in a desired format. As another example, storage/output device 1020 may constitute a printer, plotter, or other output device to generate printed or plotted expressions of the information from computer device 1005. In some embodiments, in addition or as an alternative to storing information, storage device 1020 may provide information (e.g., previously stored information) to one or more components or parts of system 1000, for example, computer device 1005.

Computer-readable medium 1025 (or computer program product) interrelates structurally and functionally to computer device 1005. Computer-readable medium 1025 stores, encodes, records, and/or embodies functional descriptive material. By way of illustration, the functional descriptive material may include computer programs, computer code, computer applications, and/or information structures (e.g., data structures, databases, and/or file systems). When stored, encoded, recorded, and/or embodied by computer-readable medium 1025, the functional descriptive material imparts functionality. The functional descriptive material interrelates to computer-readable medium 1025. In some embodiments, computer-readable medium 1025 is non-transitory, as desired.

Information structures within the functional descriptive material define structural and functional interrelations between the information structures and computer-readable medium 1025 and/or other aspects of system 1000. These interrelations permit the realization of the information structures' functionality. Moreover, within such functional descriptive material, computer programs define structural and functional interrelations between the computer programs and computer-readable medium 1025 and other aspects of system 1000. These interrelations permit the realization of the computer programs' functionality. Thus, in a general sense, computer-readable medium 1025 includes information, such as instructions, that when executed by computer device 1005, cause computer device 1005 (system 1000, generally) to provide the functionality prescribed by a process, computer program, software, firmware, method, algorithm, etc., as included (partially or entirely) in computer-readable medium 1025.

By way of illustration, computer device 1005 reads, accesses, or copies functional descriptive material into a computer memory (not shown explicitly in the figure) of computer device 1005 (or a separate block or memory circuit coupled to computer device 1005, as desired). Computer device 1005 performs operations in response to the material present in the computer memory. Computer device 1005 may perform the operations of processing a computer application that causes computer device 1005 to perform additional operations. Accordingly, the functional descriptive material exhibits a functional interrelation with the way computer device 1005 executes processes and performs operations.

Furthermore, computer-readable medium 1025 constitutes an apparatus from which computer device 1005 may access computer information, programs, code, and/or applications. Computer device 1005 may process the information, programs, code, and/or applications that cause computer device 1005 to perform additional or desired tasks or operations. Note that one may implement computer-readable medium 1025 in a variety of ways, as persons of ordinary skill in the art would understand. For example, memory within computer device 1005 (and/or external to computer device 1005) may constitute a computer-readable medium 1025, as desired.

Alternatively, computer-readable medium 1025 may include a set of associated, interrelated, coupled (e.g., through conductors, fibers, etc.), or networked computer-readable media, for example, when computer device 1005 receives the functional descriptive material from a network of computer devices or information-processing systems. Note that computer device 1005 may receive the functional descriptive material from computer-readable medium 1025, the network, or both, as desired. In addition, input(s) and/or output(s) of system 1000 may be received from, or provided to, one or more networks (not shown), as desired.

Various circuits and blocks described above and used in exemplary embodiments may be implemented in a variety of ways and using a variety of circuit elements or blocks. For example, clock generator circuit 200, random number generator 205, controller 210, clock signal generator 215 (at least the digital parts), authentication circuitry 350, debug circuitry 355, and firmware update circuitry 450 may generally be implemented using digital circuitry. The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand. In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand. The mixed-signal circuitry may include analog to digital converters (ADCs), digital to analog converters (DACs), etc.) in addition to analog circuitry and digital circuitry, as described above, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Various circuits and blocks described above and used in exemplary embodiments may be implemented in a variety of ways and using a variety of circuit elements or blocks. For example, any VCOs used in clock signal generator 215 or any other analog circuitry, for instance any analog circuitry in random number generator 205, may generally be implemented using analog circuitry. The analog circuitry may include bias circuits, decoupling circuits, coupling circuits, supply circuits, current mirrors, current and/or voltage sources, filters, amplifiers, converters, signal processing circuits (e.g., multipliers), sensors or detectors, transducers, discrete components (transistors, diodes, resistors, capacitors, inductors), analog MUXs, and the like, as desired, and as persons of ordinary skill in the art will understand. In addition, digital circuitry or mixed-signal circuitry or both may be included. The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand. The mixed-signal circuitry may include analog to digital converters (ADCs), digital to analog converters (DACs), etc.) in addition to analog circuitry and digital circuitry, as described above, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. A method of providing access to a resource in an integrated circuit (IC), the method comprising:
determining whether an attempt is made to access the resource;
obtaining a random number;
setting a frequency of a clock signal to a new value based on a value of the random number;
authenticating cryptographically a command for accessing the resource using the new value of the frequency of the clock signal.

2. The method according to claim 1, further comprising allowing access to the resource if authenticating cryptographically the command indicates that the command is valid.

3. The method according to claim 1, further comprising:
obtaining the random number again after a wait period; and
setting a frequency of a clock signal to a value based on the value of the random number.

4. The method according to claim 1, wherein setting the frequency of the clock signal to the new value based on the value of the random number further comprises setting the frequency of the clock signal to ƒ_{new}=min{max[ƒ(x), ƒₘᵢₙ], ƒₘₐₓ}, wherein x represents the random number, ƒ(x) represents a function that maps the random number to a clock frequency, and wherein min, max, ƒₘᵢₙ, and ƒₘₐₓ represent a minimum function, a maximum function, a minimum clock frequency, and a maximum clock frequency, respectively.

5. The method according to claim 4, further comprising setting the clock frequency again after a wait period.

6. The method according to claim 1, wherein the resource comprises a debug interface of the IC.

7. The method according to claim 1, wherein the resource comprises a firmware used in the IC.

8. A method of providing access to a resource in an integrated circuit (IC), the method comprising:
determining whether an attempt is made to access the resource;
authenticating cryptographically a command for accessing the resource by repeating at least once:
(a) obtaining first and second random numbers;
(b) setting a duration of a wait period based on a value of the first random number; and
(c) setting a frequency of a clock signal to a new value based on a value of the second random number for the duration of the wait period.

9. The method according to claim 8, further comprising allowing access to the resource if authenticating cryptographically the command indicates that the command is valid.

10. The method according to claim 8, wherein setting the frequency of the clock signal to the new value based on the value of the second random number further comprises setting the frequency of the clock signal to ƒ_{new}=min{max[ƒ(x), ƒₘᵢₙ], ƒₘₐₓ}, wherein x represents the second random number, ƒ(x) represents a function that maps the second random number to a clock frequency, and wherein min, max, ƒₘᵢₙ, and ƒₘₐₓ represent a minimum function, a maximum function, a minimum clock frequency, and a maximum clock frequency, respectively.

11. The method according to claim 10, wherein setting the duration of the wait period based on the value of the first random number further comprises waiting for N clock cycles, wherein N=ƒ{max[ƒ(y), Nₘᵢₙ], Nₘₐₓ}, and wherein Nₘᵢₙ and Nₘₐₓ represent, respectively, the minimum and maximum values of N.

12. The method according to claim 8, wherein the resource comprises a debug interface of the IC.

13. The method according to claim 8, wherein the resource comprises a firmware used in the IC.

14. An integrated circuit (IC), comprising:
a clock generator circuit to provide a countermeasure against an attempt to access a resource in the IC, the clock generator circuit providing at least one clock signal having a frequency derived from a first random number, wherein the at least one clock signal is used to authenticate a command used to attempt to access the resource in the IC.

15. The apparatus according to claim 14, wherein the command is authenticated cryptographically.

16. The apparatus according to claim 14, wherein the resource comprises a debug interface of the IC.

17. The apparatus according to claim 14, wherein the resource comprises a firmware used in the IC.

18. The apparatus according to claim 14, wherein the first random number is used again after a wait period to set the frequency of the at least one clock signal.

19. The apparatus according to claim 18, wherein the frequency of the at least one clock signal is set to ƒ_{new}=min{max[ƒ(x), ƒₘᵢₙ], ƒₘₐₓ}, wherein x represents the first random number, ƒ(x) represents a function that maps the first random number to a clock frequency, and wherein min, max, ƒₘᵢₙ, and ƒₘₐₓ represent a minimum function, a maximum function, a minimum clock frequency, and a maximum clock frequency, respectively.

20. The apparatus according to claim 19, wherein the wait period has a duration of N clock cycles, wherein N=ƒ{max[ƒ(y), Nₘᵢₙ], Nₘₐₓ}, and wherein y, Nₘᵢₙ and Nₘₐₓ represent, respectively, a second random number, and the minimum and maximum values of N.
